(19) United States
(12) Patent Application Publication
(10) Pub. No.: US 2003/0179396 A1
(43) Pub. Date: Sep. 25, 2003

(54) Image processing method and image processing device

(75) Inventors: Ryuichi Ishizuka, Ebina-shi (JP); Mari Kodama, Ebina-shi (JP); Yasushi Nishide, Ebina-shi (JP); Jyouji Sunada, Osaka-shi (JP); Satoshi Yoshikawa, Ebina-shi (JP); Naomi Yara, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/291,786

(22) Filed: Nov. 12, 2002

(30) Foreign Application Priority Data
Mar. 19, 2002 (JP) 2002-076855

(51) Int. Cl. B41J 1/00

(52) U.S. Cl. 358/1.9

(57) ABSTRACT

When image signals of C, M and Y color plates are processed, a triangular wave with low screen frequency is inputted to a comparator. When an image signal of K plate is processed, a triangular wave with high screen frequency is inputted to the comparator. Thus, C, M and Y colors form an image with smooth gradation and K forms an image which emphasizes thin lines. Consequently, even if an image which emphasizes gradation and an image which emphasizes thin line exist at the same time, the respective images can be formed on a recording sheet with high quality.

### BACKGROUND OF THE INVENTION

1. Field of the Invention

The present invention relates to an image processing method at a time of performing image processing for image data produced by various applications on an image processing terminal or for rendering instruction and an image processing device.

2. Description of the Related Art

Recently, an output device such as a color printer with high precision has been widely used. Such color printer is used in the field of DTP (Desktop Publishing) which requires high precision printout. The color printer is used when performing proofreading by using a page layout produced by preparing, manipulating and editing an image on a processing device such as a personal computer or a workstation prior to production of film for exposing a print plate.

The color printer performs a so-called screen processing for gradation representation. The screen processing refers to conversion of multi-valued data into binary data.

In accordance with the screen processing, when an image or the like is represented with smooth gradation by increasing the number of tone steps, a screen frequency is set to be relatively low (i.e., the number of screen lines is set to be small). By setting the screen frequency to be relatively high, reproducibility of thin lines at intermediate gradation is enhanced.

Namely, for an image for which gradation representation is important such as a photographic image, the screen processing is preferably performed at relatively low screen frequency. For an image requiring high resolution such as a line image, the screen processing is preferably performed at relatively high screen frequency.

There has been provided a color printer in which a function that a screen line (frequency at screen) at a time of performing the screen processing can be switched is provided as print function. For example, switching is possible between a gradation emphasizing screen (gradation emphasizing mode) used for images for which gradation reproduction is important such as a natural image or a photographic image and a thin line emphasizing screen (thin line emphasizing mode) used for images for which reproduction of thin line is important such as a character or a map.

Such a color printer having the function of switching the screen line has, however, a problem in that when an image for which reproduction of thin line is important and an image for which reproduction of gradation is important exist on the same screen (the page), the color printer can correspond to only one of the images.

Japanese Patent Application Laid-Open (JP-A) No. 2001-53969 discloses a technique in which image data of a random area within a screen is sampled, an image reproduced at each of image modes (gradation emphasizing mode and thin line emphasizing mode) is compared to an original image, and an optimal mode (the number of screen lines) for the corresponding area is automatically selected.

However, in order to carry out such a technique, sampling of image and optimal image mode must be selectable. For this reason, complicated hardware must be provided, resulting in an increase in cost. Further, there also arises a problem in that productivity is decreased because complicated software processing must be performed.

### SUMMARY OF THE INVENTION

The present invention was developed in light of the above-described circumstances, and an object of the present invention is to provide an image processing method and an image processing device in which quality of a printout image can be improved by improving reproducibility of thin line while not deteriorating reproducibility of gradation.

In order to accomplish the aforementioned object, the present invention provides an image processing method which performs gradation emphasizing screen processing with low screen frequency and thin line emphasizing screen processing with high screen frequency when an image processing is performed on a basis of image data or rendering instruction inputted from an image processing terminal. In accordance with such image processing method, when the image data is divided into cyan, magenta, yellow and black image signals and the screen processing is performed for each of these image signals, the screen frequency is switched between at least one of the cyan, magenta, yellow and black and the rest of the colors.

In accordance with the present invention, when the image data is divided into cyan, magenta, yellow and black image signals and the screen processing is performed for each of the image signals, a thin line emphasizing screen processing is performed for at least one image signal.

Thus, a color subjected to the thin line emphasizing screen processing has high resolution and other colors have smooth gradation. An image which emphasizes thin lines and an image which emphasizes gradation can be formed together depending on colors for forming a color image.

In accordance with the present invention, a screen frequency at a time of performing the screen processing for the black image signal may be high and a screen frequency at a time of performing the screen processing for the cyan, magenta and yellow image signals may be low.

In accordance with the present invention, the thin line emphasizing screen processing is performed only for a black image and the gradation emphasizing screen processing is performed for cyan, magenta and yellow.

Cyan, magenta and yellow are usually used in an image that gradation reproduction is important. Then, by performing the screen processing such that gradation of cyan, magenta and yellow is smooth, a color image with high quality can be formed. Black is usually used in an image such as a character or a map. Thus, for black, by performing the screen processing such that an image is formed with high precision, batter of character or thin line on a map can be reliably prevented.

Accordingly, even if an image that reproducibility of gradation is important such as a natural image or a photographic image and an image that reproducibility of thin line is important such as a character or a map exist on a screen (a page), the screen processing can be appropriately performed for the respective images and the resultant images can be finished with high quality.

An image processing device used for the present invention performs an image processing on a basis of image data or rendering instruction inputted from an image processing terminal. The image processing device comprises a gradation emphasizing screen processing device which performs a screen processing at a screen frequency set for gradation emphasizing, a thin line emphasizing screen processing device which performs the screen processing at a screen frequency for thin line emphasizing which is set to be higher than the screen frequency and a setting device which sets such that the screen processing is performed by the thin line emphasizing screen processing device for at least one color image signal of cyan, magenta, yellow and black image signals obtained by decomposing the image data and that the screen processing is performed by the gradation emphasizing screen processing device for other color image signals.

Thus, even if an image which emphasizes gradation and an image which emphasizes thin lines exist, the respective images can be formed with low cost and high quality at high speed.

The present invention may further comprise a setting device which sets to gradation emphasizing, thin line emphasizing or mixed processing of the gradation emphasizing and the thin line emphasizing and a selecting device which selects such that when the mixed processing is set by the setting device, the screen processing is performed by the thin line emphasizing screen processing device for at least one image signal of cyan, magenta, yellow and black image signals obtained by decomposing the image data and the screen processing is performed by the gradation emphasizing screen processing device for other color image signals.

The selecting device may select such that the screen processing is performed by the thin line emphasizing screen processing device only for the black image data.

When a color for thin line emphasizing is set, the selecting device may perform the screen processing for the corresponding color so as to emphasize thin line and the screen processing for other colors so as to emphasize gradation. Thus, even if a character or a map is formed by a color other than black, appropriate processing can be performed.

In accordance with the image processing device of the present invention, the setting device may be provided at the image processing terminal.

In accordance with the image processing device of the present invention, the selecting device may comprise an oscillating device which generates a screen signal with screen frequency set for gradation emphasizing or thin line emphasizing and a switching device which switches a screen frequency outputted from the oscillating device in accordance with a color image signal to be subjected to screen processing.

As described above, in accordance with the present invention, an excellent effect that even if an image which emphasizes gradation and an image which emphasizes thin lines exist, the respective images can be finished with high quality can be obtained. Further, in accordance with the present invention, image processing for finishing the image which emphasizes gradation and the image which emphasizes thin lines with high quality can be performed with reduced cost at high speed.

### BRIEF DESCRIPTION OF THE DRAWINGS

FIG. 1 is a schematic structural view of network used for this embodiment.

FIG. 2 is a schematic view of setting dialogue serving as an example of user interface.

FIG. 3 is a functional view showing an example of screen processing section which performs line screen processing.

FIG. 4A is a schematic diagram showing an example of triangular wave when gradation emphasizing screen processing is performed.

FIG. 4B is a schematic diagram showing an example of triangular wave when thin line emphasizing screen processing is performed.

FIG. 5A is a diagram showing an example of image signal inputted to a comparator and triangular wave for gradation emphasizing.

FIG. 5B is a diagram showing an example of image output signal outputted from the comparator.

FIG. 5C is a schematic view showing an example of gradation emphasizing screen.

FIG. 5D is a conceptual view showing an example of display image which is edited on an application for 30% solid image.

FIG. 5E is a conceptual view showing an example of display image which is edited on an application for 30% 1 dot line image.

FIG. 6A is a diagram showing an example of image signal inputted to a comparator and triangular wave for thin line emphasizing.

FIG. 6B is a diagram showing an example of image output signal outputted from the comparator.

FIG. 6C is a schematic view showing an example of thin line emphasizing screen.

FIG. 6D is a conceptual view showing an example of display image which is edited on an application for 30% solid image.

FIG. 6E is a conceptual view showing an example of display image which is edited on an application for 30% 1 dot line image.

FIG. 7 is a flowchart showing an example of screen processing on a basis of setting of screen type.

FIG. 8 is a functional block diagram showing an example of screen processing section which performs a dot screen processing.

FIG. 9A is a schematic view showing an example of gradation emphasizing dot screen.

FIG. 9B is a conceptual view showing an example of display image which is edited on an application for 30% solid image.

FIG. 9C is a conceptual view showing an example of display image which is edited on an application for 30% 1 dot line image.

FIG. 10A is a schematic view showing an example of gradation emphasizing dot screen.

FIG. 10B is a conceptual view showing an example of display image which is edited on an application for 30% solid image.

FIG. 10C is a conceptual view showing an example of display image which is edited on an application for 30% 1 dot line image.

### DESCRIPTION OF THE PREFERRED EMBODIMENTS

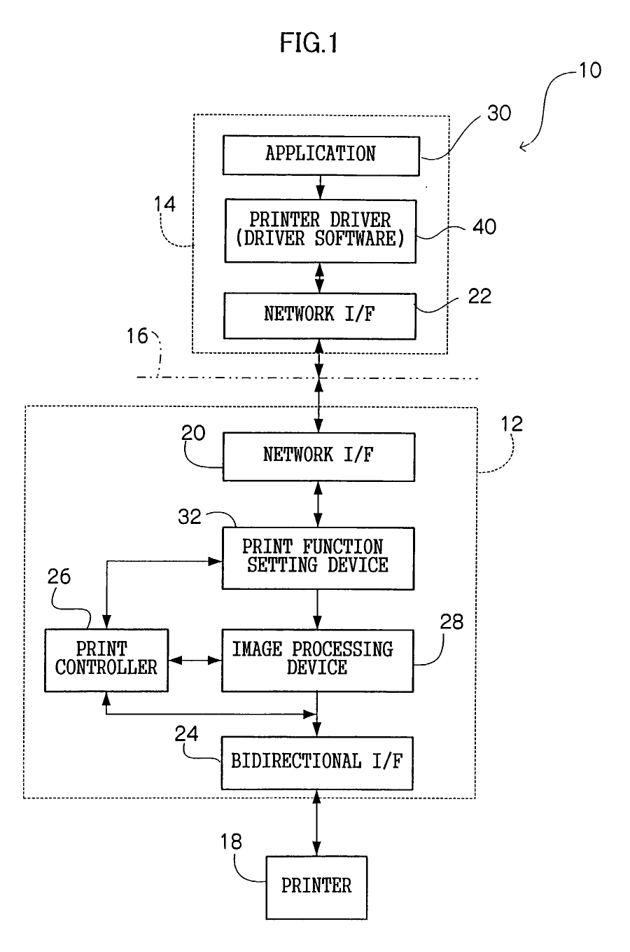

Hereinafter, embodiments of the present invention will be described with reference to the drawings. FIG. 1 shows a schematic structure of network 10 which is applied to this embodiment. In accordance with the network 10, a print server 12 which is provided as an image processing device to which the present invention is applied is connected by network via a communication line 16 to a plurality of client terminals 14 provided as image processing terminals.

A printer 18 serving as a printout device is connected to the print server 12. When the print server 12 receives a print job outputted from a client terminal 14, the print server 12 performs printout in accordance with the print job. A case of using an image processing device as a print server will be described hereinafter. The image processing device of the present invention is not limited to a print server and may be provided at various intermediate servers such as a file server connected by network to the client terminals 14 and the like and perform image processing.

The print server 12 is provided with a network interface (network I/F) 20 and each of the client terminals 14 is provided with a network interface 22. The print server 12 and the client terminals 14 are connected via the network I/F 20, 22 to the communication line 16. The print server 12 includes a bidirectional interface (bidirectional I/F) 24 such as an Ethernet (R) or the like. The print server 12 is connected via the bidirectional I/F 24 to the printer 18. A plurality of printers 18 may be connected to the print server 12. A plurality of bidirectional I/F 24 may be provided or various kinds of bidirectional I/F 24 may be provided.

As network connection of a plurality of client terminals 14 and the print server 12, LAN (Local Area Network) connection such as Apple Talk and Ethernet (R) (e.g., Ether Talk) may be applied, or WAN (Wide Area Network) may be applied. Namely, connection by any network protocols may be utilized for the network connection of a plurality of client terminals 14 and the print server 12.

The print server 12 may be configured by adding a personal computer (PC) to a PCI board having a predetermined function. The print server 12 has an input device such as a keyboard or a mouse and a display device such as a CRT display or an LCD. The print server 12 may have a WYSIWYG function of processing an image displayed on a display device and printouting the displayed image.

The print server 12 is provided with a print controller 26 which controls the printer 18 and an image processing section 28. The image processing section 28 performs RIP processing which generates raster data on a basis of job data such as image data or rendering data inputted from a client terminal 14 as a print job.

Further, the print server 12 stores the inputted print job in a processing wait queue, reads successively the print job stored in the processing wait queue and performs image processing (RIP processing). The print server 12 stores data subjected to image processing (raster data) in a print wait queue and successively outputs the raster data from the print wait queue to the printer 18. The print server 12 stores a job that a print processing is not designated or a job that a print processing cannot be performed in a holding queue. Such print server 12 may have known various structures and a detailed description thereof will be omitted in this embodiment.

The client terminal 14 has various applications 30. The client terminal 14 performs image processing such as preparation, manipulation and edit for image and document preparation by using the applications 30. The client terminal 14 sends produced image data or rendering data and various processing designations to the print server 12 as a print job. The print server 12 performs a designated image processing for the print job and outputs a resultant job to the printer 18. Then, the printer 18 outputs a printed matter corresponding to the print job.

The print server 12 is provided with a print function setting device 32. When the print server 12 receives a job such as a print job, the print server 12 sets various print functions designated in the print job. The print server 12 can set various conventionally known print functions. The print function setting device 32 judges a print function designated in a print job and performs setting such that the print function is performed by the image processing section 28 and the printer controller 26. In this embodiment, a detailed description of the print function setting device 32 will be omitted.

A driver software (printer driver) 40 for setting various print functions provided at the print server 12 is incorporated into the client terminal 14. When the client terminal 14 asks a print processing for image data formed by the application 30 or rendering instruction, the client terminal 14 can set various print functions provided at the print server 12 by using the driver software 40.

The print sever 12 can perform a screen processing by switching between a photograph mode which emphasizes gradation and a map mode which emphasizes thin lines.

Correspondingly, the client terminal 14 can select a mode by using the driver software 40. Namely, the client terminal 14 can select a screen type.

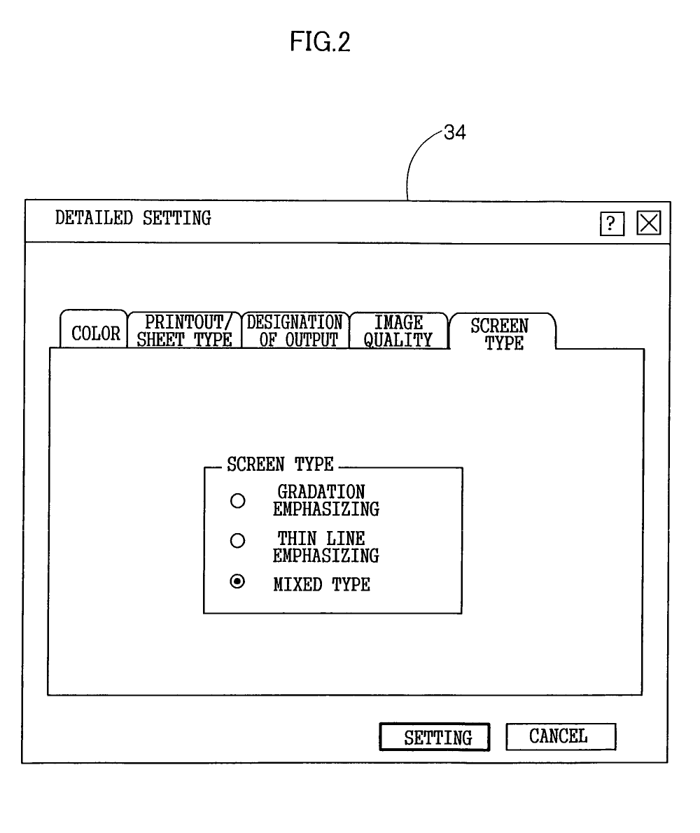

Referring to FIG. 2, a setting dialogue 34 serving as an example of user interface for switching the screen type on the client terminal 14 is shown. The setting dialogue 34 is displayed by, for example, selecting the screen type in a state of designating a print processing.

At the setting dialogue 34, “gradation emphasizing (photograph mode)” or “thin line emphasizing (map mode)” can be selected as the screen type. Further, at the setting dialogue 34, “mixed type” can be selected as the screen type. The user interface is not limited to this user interface and may apply any structures. In accordance with this embodiment, selection and setting are performed at the client terminal 14. Nevertheless, selection and setting may be performed on the print server 12.

An intermediate density at a time of forming an image on a recording sheet is represented by a line and a dot. The screen processing includes a line screen processing and a dot screen processing.

The present invention may use any screen processings. A line screen processing and a dot screen processing will be described hereinafter.

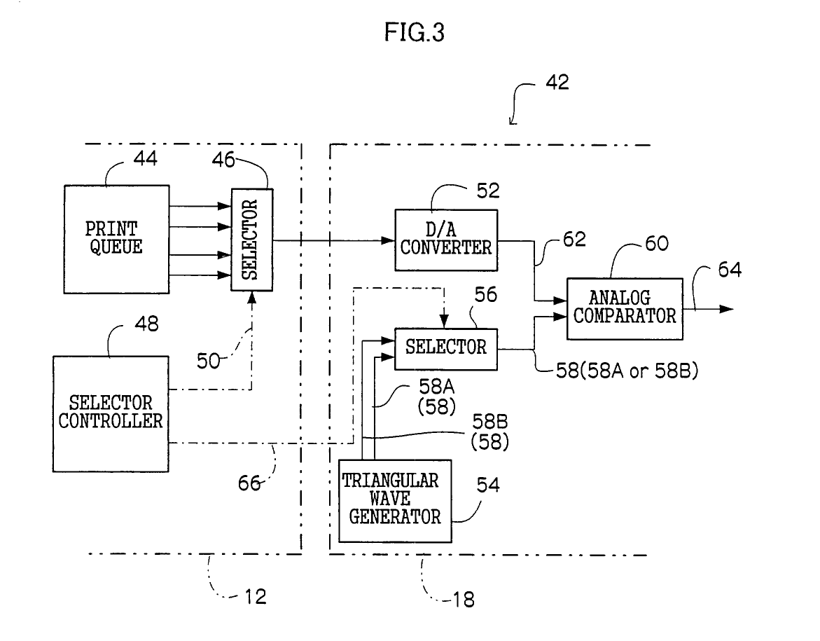

FIG. 3 shows a functional block diagram of screen processing device 42 enabling a line screen processing.

In the print server 12, raster data of cyan (C), magenta (M), yellow (Y) and black (K) (which hereinafter are referred to as C plate, M plate, Y plate and K plate) is held as image data in a print queue 44. The raster data is outputted to the printer 18 via a selector 46. A selector 48 is formed at the print server 12. The selector 48 successively outputs a selection signal 50 of C plate, M plate, Y plate or K plate to the selector 46.

Thus, if the selection signal 50 selects a K plate, the selector 46 outputs raster data (image data) of the K plate held at the print queue 44. If the selection signal 50 selects a C plate, the selector 46 outputs raster data (image data) of the C plate. Namely, the selector 46 successively outputs image data of C plate, M plate, Y plate or K plate on a basis of a selection signal 50 inputted from the selector 48. An output order may be determined in advance, or may depend on an output request of the printer 18 or may be arbitrary order.

On the other hand, the printer 18 is provided with a D/A converter 52. Image data which is outputted from the print server 12 is inputted to the D/A converter 52. Thus, the image data which is a digital signal is converted into an analog signal by the D/A converter 52.

An analog wave generator 54 which generates an analog wave (which hereinafter is referred to as “triangular wave generator 54”) and a selector 56 are also provided at the printer 18.

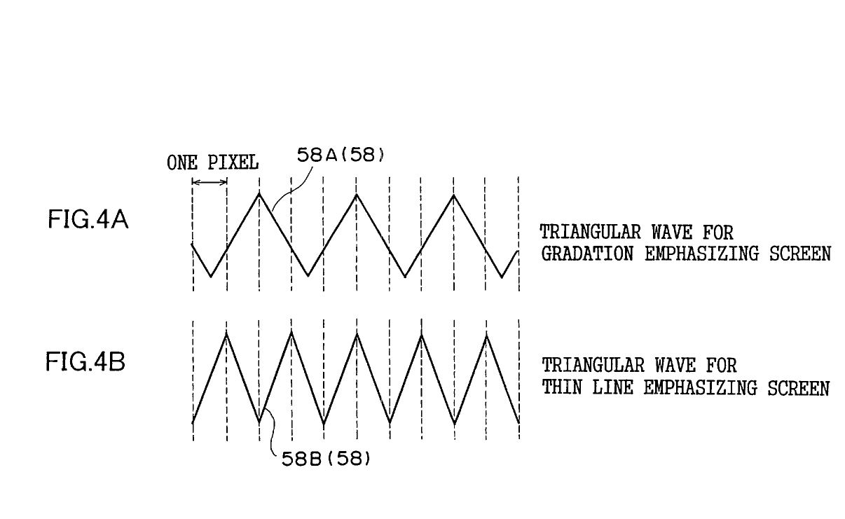

As shown in FIGS. 4A and 4B, the triangular wave generator 54 outputs a triangular wave 58 with a predetermined screen frequency. At this time, the triangular wave generator 54 outputs, as the triangular wave 58, a triangular wave 58A which emphasizes gradation or a triangular wave 58B which emphasizes thin lines. According to a period of the triangular wave 58A emphasizing gradation, one cycle corresponds to, e.g., three pixels. According to a period of the triangular wave 58B emphasizing thin line, one cycle corresponds to, e.g., two pixels. Namely, a screen frequency of the triangular wave 58A emphasizing gradation is lower than that of the triangular wave 58B emphasizing thin line.

As shown in FIG. 3, the triangular wave generator 54 is connected to the selector 56. Thus, the triangular waves 58A and 58B are inputted to the selector 56.

A comparator 60 is provided at the printer 18. The selector 56 outputs one of the triangular waves 58A and 58B inputted from the triangular wave generator 54 to the comparator 60. Image data (image signal 62) converted into an analog signal is inputted from the D/A converter 52 to the comparator 60.

The comparator 60 outputs an image signal (image output signal 64) depending on a triangular wave 58 (58A or 58B). The printer 18 forms an image on a recording sheet (not shown) in accordance with the image output signal 64.

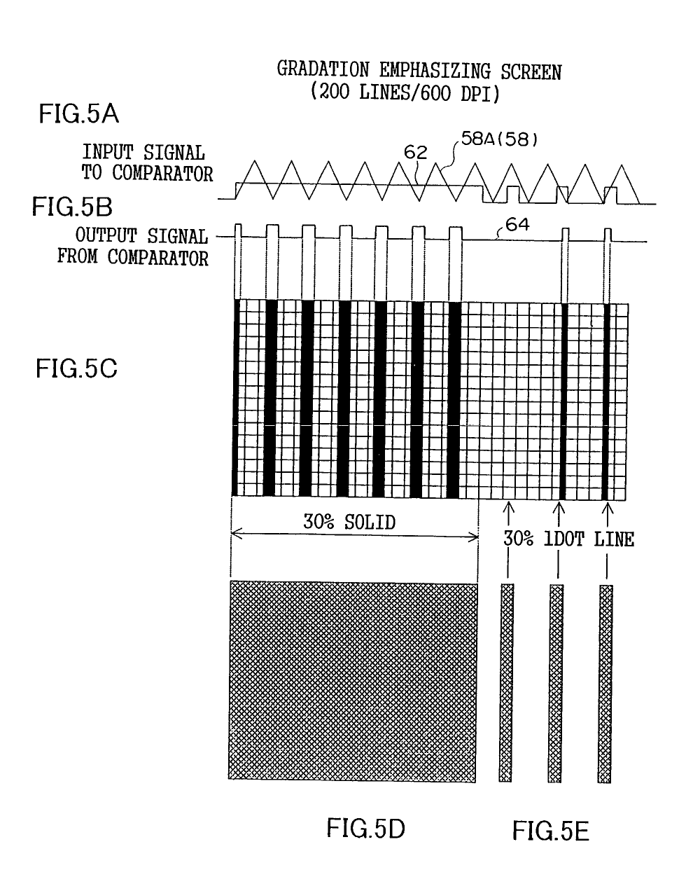

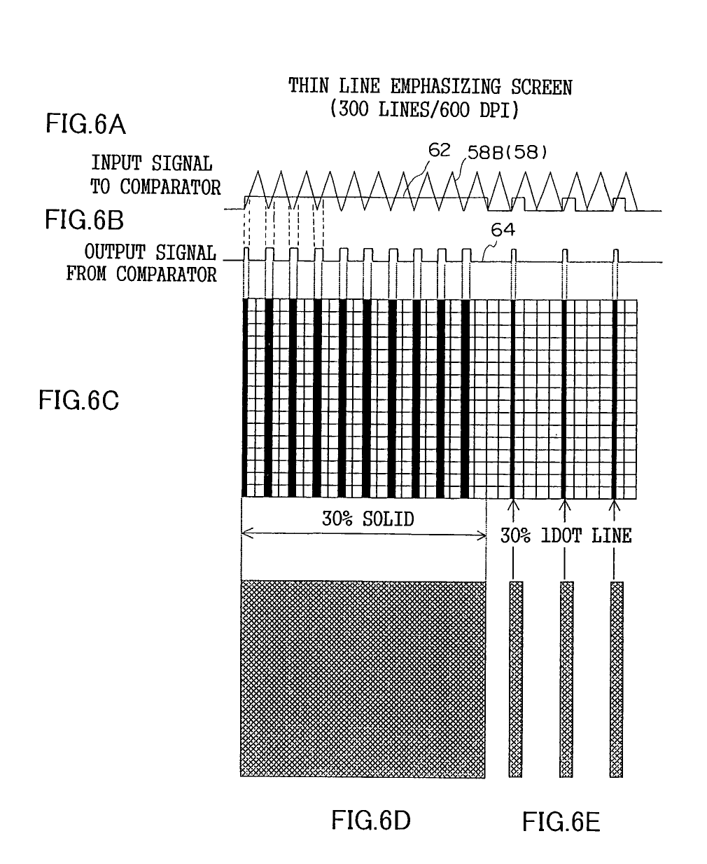

As shown in FIGS. 5A, 5B, 6A and 6B, the comparator 60 outputs high level image output signal 64 when an image signal 62 exceeds the triangular wave 58 and low level image output signal 64 when the image signal 62 does not exceed the triangular wave 58. In this way, the image signal 62 is subjected to screen processing by the screen processing device 42 depending on a screen frequency of the triangular wave 58 and is outputted as binary image output signal 64.

As shown in FIG. 3, a selector 48 provided at the print server 12 is connected to the selector 46. The selector 48 outputs a screen setting signal 66 for switching triangular waves 58A and 58B to the selector 56. The selector 56 switches the triangular wave 58 to be outputted to the comparator 60 in accordance with the screen setting signal 66. Namely, the selector 56 outputs the triangular wave 58 having a screen frequency corresponding to the screen setting signal 66 inputted from the selector 48.

The selector 48 outputs the selection signal 50 and the screen setting signal 66 on a basis of a screen type set at the client terminal 14.

When the screen type is set as gradation emphasizing, the selector 48 outputs the screen setting signal 66 such that the triangular wave 58A with lower screen frequency is inputted to the comparator 60. When the screen type is set as thin line emphasizing, the selector 48 outputs the screen setting signal 66 such that the triangular wave 58B with higher screen frequency is inputted to the comparator 60.

When the screen type is set as gradation emphasizing, for 30% solid image shown in FIG. 5D, as shown in the left side of the page surface of FIG. 5C, an image output signal 64 corresponding to relatively wide band-shaped screen pattern is obtained. For 30% one dot line image shown in FIG. 5E, as shown in the right side of the page surface of FIG. 5C, an image output signal 64 corresponding to decimated screen pattern is obtained.

When the screen type is set as thin line emphasizing, for 30% solid image shown in FIG. 6D, as shown in the left side of the page surface of FIG. 6C, an image output signal 64 corresponding to narrow screen pattern is obtained. For 30% one dot line image shown in FIG. 6E, as shown in the right side of the page surface of FIG. 6C, an image output signal 64 which is not subjected to decimation and corresponds to a narrow screen pattern is obtained.

FIGS. 5A through 5D show, for example, a gradation emphasizing screen with 200 lines at 600 dpi. FIGS. 6A through 6C show, for example, a thin line emphasizing screen at 300 lines at 600 dpi.

When a screen type is set as a mixed type, the selector 48 outputs selection signals 50 of C, M and Y plates and a screen setting signal 66 such that the selector 56 outputs a triangular wave 58A. The selector 48 outputs a selection signal 50 of K plate to the selector 46 and a screen setting signal 66 such that the selector 56 outputs a triangular wave 58B.

Thus, at the print server 12, gradation of C, M and Y is smooth and color K is recorded with high precision.

Outlines of print processing using a print server 12 on a network 10 and screen processing at the screen processing device 42 will be described as an operation of this embodiment.

At the network 10, image data which is prepared, manipulated and edited by using the application 30 or a rendering instruction is outputted to the print server 12 as a print job.

The print server 12 receives a job outputted from the client terminal 14. When the job is a print job, the print function setting device 32 reads and sets a print function. The image processing section 28 performs RIP processing for forming raster data from the image data or the rendering instruction which is a print job.

The raster data generated at the image processing section 28 is outputted to the printer 18 at a predetermined timing. Then, the printer 18 performs printout on a basis of the image data or the rendering instruction which is a print job.

The client terminal 14 can set a screen type by using the driver software 40. The mixed type as well as the gradation emphasizing screen (photograph mode) and the thin line emphasizing screen (map mode) can be selected as the screen type.

If the screen type is set at the client terminal 14, the print server 12 performs the screen processing on a basis of the set screen type and forms an image on a recording sheet.

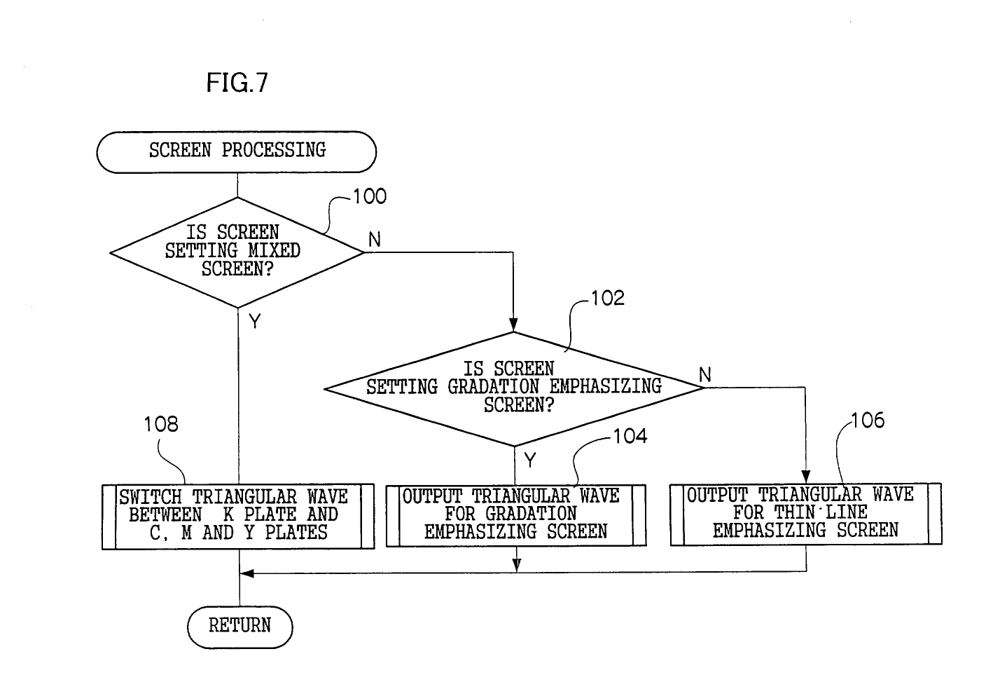

FIG. 7 shows an outline of screen processing at the screen processing device 42 formed between the print server 12 and the printer 18.

This flowchart is effected when the screen type is set and thus the image data is outputted from the print server 12 to the printer 18. At first step 100, whether or not a set screen type is a mixed type is determined.

At this time, if the screen type is not the mixed type but gradation emphasizing (photograph mode) or thin line emphasizing (map mode), the answer to the determination in step 100 is negative and a process proceeds to step 102. At step 102, whether or not the screen type is set as gradation emphasizing is determined.

If the screen type is set as gradation emphasizing, the answer to the determination in step 102 is affirmative and a process proceeds to step 104. At step 104, setting is performed such that a triangular wave 58 (58A) for gradation emphasizing screen is outputted. Namely, the screen type is set as gradation emphasizing and a processing is performed.

When the screen type is set as gradation emphasizing, the selector 48 outputs the screen setting signal 66 to the selector 56 such that the triangular wave 58A with lower screen frequency is selected. The selector 56 selects the triangular wave 58A from triangular waves 58A and 58B inputted from the triangular wave generator 54 and outputs the selected triangular wave 58A to the comparator 60.

The comparator 60 performs a screen processing for the image signal 62 inputted from the D/A converter 52 by using the triangular wave 58A and outputs the image output signal 64.

An image is formed on a recording sheet on a basis of the image output signal 64 and then outputted. Thus, an image with smooth gradation of C, M, Y and K is formed on a recording sheet.

If the screen type is set as thin line emphasizing, the answer to the determination in step 102 is negative and the process proceeds to step 106. In step 106, setting is performed such that a triangular wave 58 (58B) for thin line emphasizing screen is outputted. Namely, the screen type is set as thin line emphasizing and a processing is performed.

If the screen type is set as thin line emphasizing, the selector 48 outputs the screen setting signal 66 to the selector 56 such that a triangular wave 58B with higher screen frequency is selected. The selector 56 selects the triangular wave 58B from triangular waves 58A and 58B inputted from the triangular wave generator 54 and outputs the selected triangular wave 58B to the comparator 60.

The comparator 60 performs a screen processing for the image signal 62 inputted from the D/A converter 52 by using the triangular wave 58B and outputs the image output signal 64.

An image is formed on a recording sheet on a basis of the image output signal 64 and then outputted. Thus, an image, that C, M, Y and K colors are recorded with high resolution and fine characters and fine lines are not defaced, is formed on a recording sheet.

If a mixed type is selected as the screen type, the answer to the determination in step 100 is affirmative and a process proceeds to step 108. In step 108, when the image data of C, M and Y (C, M and Y plates) is outputted, the screen type is set as gradation emphasizing and when the image data of K (K plate) is outputted, the screen type is set as thin line emphasizing.

In this way, in a case that the mixed type is selected, when outputting the selection signal 50 for selecting the image data of C, M and Y plates to the selector 46, the selector 48 outputs the screen setting signal 66 to the selector 56 such that a screen processing is performed by using a triangular wave 58A with lower screen frequency. When outputting the selection signal 50 for selecting the image data of K plate to the selector 46, the selector 48 outputs the screen setting signal 66 to the selector 56 such that a screen processing is performed by using a triangular wave 58B with higher screen frequency.

Then, the comparator 60 performs the screen processing for the image signals 62 of C, M and Y plates inputted from the D/A converter 52 by using the triangular wave 58A and outputs the image output signal 64. The comparator 60 performs the screen processing for the image signal 62 of K plate inputted from the D/A converter 52 by using the triangular wave 58B and outputs the image output signal 64.

In this way, an image is formed on a recording sheet on a basis of the outputted image signal 64. Thus, on a recording sheet, C, M and Y colors are recorded with smooth gradation and K color is recorded with high resolution. Namely, a color image formed by using C, M and Y is formed with smooth gradation and high quality, and single color (K color) character or thin line is formed with high resolution.

Even if an image that reproduction of thin line is important such as a character or a map and a natural image or a photographic image that reproduction of gradation is important exist on the same page, the respective images can be formed with high quality.

In general, C, M and Y colors are frequently used in an image that reproduction of gradation is important. Then, by performing the screen processing such that gradation of the respective C, M and Y colors is smooth, a color image with high quality can be formed. The K color is usually used in an image such as a character or a map. Then, for the K color, by performing the screen processing such that an image is formed with high precision, batter of character or thin line on a map can be reliably prevented.

At this time, the screen processing device 42 formed between the print server 12 and the printer 18 does not require either a complicated hardware nor a complicated image processing. Thus, a processing with low cost and high speed can be realized.

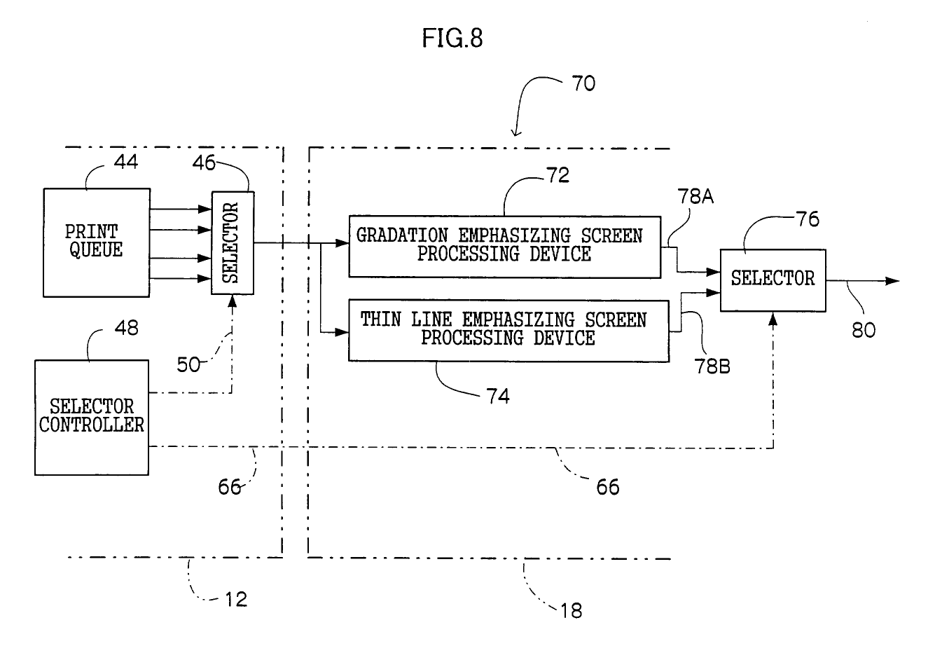

An outline of dot screen processing will be described with reference to FIGS. 8 through 10.

FIG. 8 shows a functional block diagram of screen processing device 70 enabling a dot screen processing. In the screen processing device 70 which will be described below, the same components as those of the above-described screen processing device 42 are denoted by the same reference numerals and a detailed description thereof will be omitted.

The screen processing device 70 is provided with a gradation emphasizing screen processing device 72 and a thin line emphasizing screen processing device 74. Image data outputted from the selector 46 is inputted to the gradation emphasizing screen processing device 72 and the thin line emphasizing screen processing device 74.

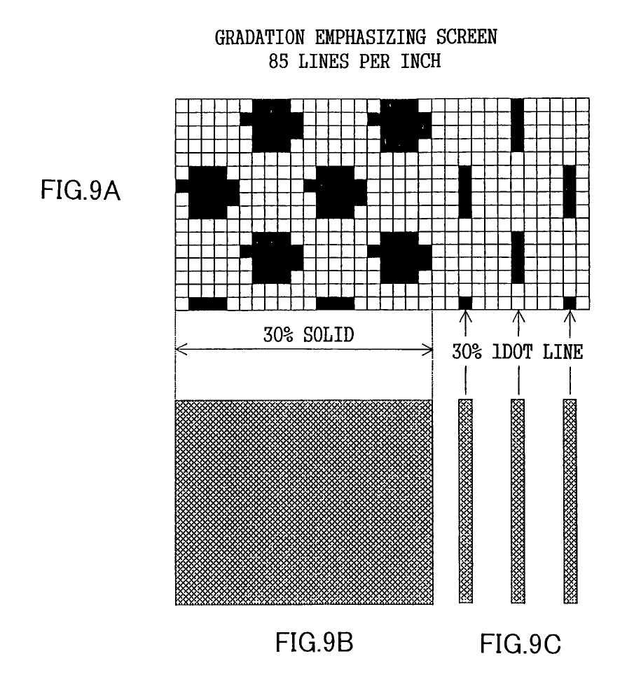

In accordance with the gradation emphasizing screen processing device 72, for 30% solid image shown in FIG. 9B, a dot image shown in the left side of the page surface of FIG. 9A is obtained. Further, in accordance with the gradation emphasizing screen processing device 72, for 30% dot line image shown in FIG. 9C, a dot image shown in the right side of the page surface of FIG. 9A is obtained.

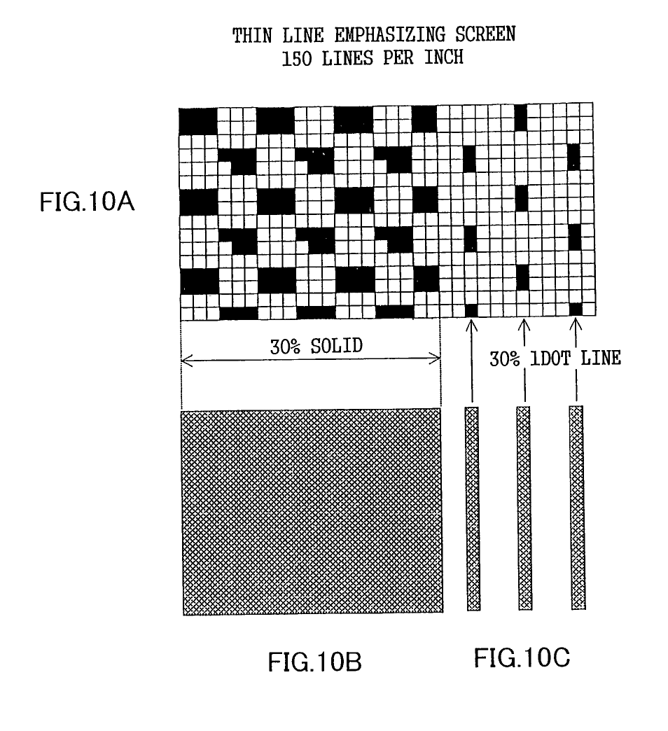

In accordance with the thin line emphasizing screen processing device 74, for 30% solid image shown in FIG. 10B, relatively fine dot image shown in the left side of the page surface of FIG. 10A is obtained. Further, in accordance with the thin line emphasizing screen processing device 74, for 30% dot line image shown in FIG. 10C, relatively fine dot image shown in the right side of the page surface of FIG. 10A is obtained. FIG. 9A shows 85 lines per inch and FIG. 10A shows 150 lines per inch.

Such gradation emphasizing screen processing device 72 may apply general structure in which conventionally known gradation emphasizing screen processing is performed by using a triangular wave (e.g., triangular wave 58A) with lower screen frequency. The thin line emphasizing screen processing device 74 may apply general structure in which conventionally known thin line emphasizing screen processing is performed by using a triangular wave (e.g., triangular wave 58B) with higher screen frequency. Accordingly, detailed descriptions of the gradation emphasizing screen processing device 72 and the thin line emphasizing screen processing device 74 will be omitted.

The printer 18 is provided with a selector 76. An image signal 78A subjected to screen processing at the gradation emphasizing screen processing device 72 and an image signal 78B subjected to screen processing at the thin line emphasizing screen processing device 74 are inputted to the selector 76.

The selector 48 is connected to the selector 76. A screen setting signal 66 outputted from the selector 48 is inputted to the selector 76. Then, the selector 76 selects one of image signals 78A and 78B depending on the screen setting signal 66 and outputs as the image output signal 80. In this way, the printer 18 forms an image on a recording sheet (not shown) in accordance with the image output signal 80.

When a screen type is set as gradation emphasizing, the selector 48 outputs the screen setting signal 66 to the selector 76 such that the image signal 78A outputted from the gradation emphasizing screen processing device 72 is outputted as the image output signal 80. When a screen type is set as thin line emphasizing, the selector 48 outputs the screen setting signal 66 to the selector 76 such that the image signal 78B outputted from the thin line emphasizing screen processing device 74 is outputted as the image output signal 80.

If the screen type is set as a mixed type, at a time of outputting the selection signals 50 of C, M and Y plates to the selector 46, the selector 48 outputs the screen setting signal 66 such that the selector 76 outputs the image signal 78A inputted from the gradation emphasizing screen processing device 72 as the image output signal 80. At a time of outputting the selection signal 50 of K plate to the selector 46, the selector 48 outputs the screen setting signal 66 such that the selector 76 outputs the image signal 78B inputted from the thin line emphasizing screen processing device 74 as the image signal 80.

In accordance with the screen processing device 70 with such structure, if the screen type is set as gradation emphasizing, an image with improved gradation reproducibility can be recorded. If the screen type is set as thin line emphasizing, an image with improved thin line reproduction can be recorded.

In accordance with the screen processing device 70, if the screen type is set as a mixed type, when outputting the selection signal 50 for selecting the image data of C, M and Y plates to the selector 46, the selector 48 outputs the screen setting signal 66 such that the image signal 78A outputted from the gradation emphasizing screen processing device 72 is outputted as the image signal 80. When outputting the selection signal 50 for selecting the image data of K plate to the selector 46, the selector 48 outputs the screen setting signal 66 such that the image signal 78B subjected to the screen processing at the thin line emphasizing screen processing device 74 is outputted as the image output signal 80.

Consequently, an image formed on a basis of the image output signal 80 is recorded with smooth gradation of C, M and Y colors and high resolution of K color. Namely, a color image formed by using C, M and Y is formed with smooth gradation and high quality, and single color (K color) character or thin line is formed with high resolution.

Accordingly, even if an image such as a character or a map that reproduction of thin line is important and a natural image or a photographic image that reproduction of gradation is important exist on the same page, each of the images can be formed with high quality.

The above-described embodiment does not limit a structure of the present invention. For example, in accordance with this embodiment, the screen processing device 42 or 70 is formed between the print server 12 and the printer 18 but the present invention is not limited to this arrangement. For example, the screen processing device 42 or 70 may be formed at the print server 12 and output processed image data to the printer 18.

In accordance with this embodiment, a thin line emphasizing screen processing is performed for an image signal of K plate and a gradation emphasizing screen processing is performed for C, M and Y plates. Nevertheless, colors subjected to thin line emphasizing screen processing and the number of such colors are not limited. For example, a color for forming a character or the like may be set such that the thin line emphasizing screen processing is performed and selected. Thus, an image processing is possible for an image in which a thin line such as a character is formed any one of C, M and Y so as to obtain an image with high quality.

Further, in accordance with this embodiment, although the present invention is applied to the print server 12 or the printer 18 on the network 10, the present invention is not limited to this structure. For example, the present invention may be applied to an image processing device with any structure which is connected to a network.

What is claimed is:

1. An image processing method, which performs gradation emphasizing screen processing with low screen frequency and thin line emphasizing screen processing with high screen frequency when performing image processing on the basis of image data or rendering instructions inputted from an image processing terminal,
wherein, when said image data is divided into cyan, magenta, yellow and black image signals and the screen processing is performed for each of the image signals, said screen frequency is switched between at least one of said cyan, magenta, yellow and black and the rest of them and the screen processing is performed.

2. The image processing method according to claim 1, wherein the screen frequency is set to be high when the screen processing is performed for said black image signal, and the screen frequency is set to be low when the screen processing is performed for said cyan, magenta and yellow image signals.

3. An image processing device, which performs image processing on the basis of image data or rendering instructions inputted from an image processing terminal, the device comprising:
gradation emphasizing screen processing means which performs screen processing at a screen frequency set for gradation emphasizing;
thin line emphasizing screen processing means which performs screen processing at a screen frequency for thin line emphasizing, which is set to be higher than said screen frequency set for gradation emphasizing; and
setting means which sets such that the screen processing is performed by said thin line emphasizing screen processing means for at least one color image signal of cyan, magenta, yellow and black image signals obtained by decomposing said image data and the screen processing is performed by said gradation emphasizing screen processing means for other color image signals.

4. The image processing device according to claim 3 further comprising:
setting means which sets to gradation emphasizing, thin line emphasizing or mixed processing of the gradation emphasizing and the thin line emphasizing; and
selecting means which selects such that, when the mixed processing is set by said setting means, the screen processing is performed by said thin line emphasizing screen processing means for at least one image signal of cyan, magenta, yellow and black image signals obtained by decomposing said image data and the screen processing is performed by said gradation emphasizing screen processing means for other color image signals.

5. The image processing device according to claim 4, wherein said selecting means selects such that only said black image signal is subjected to screen processing by said thin line emphasizing screen processing means.

6. The image processing device according to claim 4, wherein said setting means is provided at said image processing terminal.

7. The image processing device according to claim 4, wherein said selecting means comprises:
oscillating means, which generates a screen signal with a screen frequency set for said gradation emphasizing or said thin line emphasizing; and
switching means, which switches a screen frequency outputted from said oscillating means in accordance with a color image signal to be subjected to screen processing.

8. An image processing device comprising:
binarization means which performs binarization at different screen frequencies for color data of a plurality of colors, which color data forms image data, said different screen frequencies including a screen frequency used for binarization of color data of at least one of the colors and a screen frequency used for binarization of color data of the colors other than said at least one of the colors; and
output means, which outputs binary data subjected to binarization by said binarization means.

9. The image processing device according to claim 8, wherein said binarization means sets a screen frequency used for binarization of black data to be higher than a screen frequency used for binarization of color data of colors other than black.

10. The image processing device according to claim 8, wherein said binarization means comprises:
a digital/analog converter, which converts multi-valued color data from a digital data into an analog data;
an analog wave generator, which generates an analog wave having said screen frequency; and
an analog comparator which compares color data outputted from said digital/analog converter to the analog wave outputted from said analog wave generator and outputs binary data indicating a result of the comparison.

11. The image processing device according to claim 10, wherein said analog wave generator generates a triangular wave.

12. The image processing device according to claim 8, wherein said binarization means comprises:
a digital/analog converter, which converts multi-valued color data from a digital data into an analog data;
an analog wave generator, which generates two analog waves having different screen frequencies;
analog wave selecting means, which selects an analog wave from the two analog waves generated by said analog wave generator; and
an analog comparator, which compares color data outputted from said digital/analog converter to the analog wave selected by said analog wave selecting means and outputs binary data indicating a result of the comparison.

13. The image processing device according to claim 8, wherein said binarization means comprises:
first color data binarization means, which performs binarization for color data at a first screen frequency and outputs binary data;
second color data binarization means, which performs binarization for the color data at a second screen frequency different from said first screen frequency and outputs binary data; and
binary data selecting means, which selects one of binary data outputted from said first color data binarization means and binary data outputted from said second color data binarization means.

14. The image processing device according to claim 13 further comprising screen type selecting means for selecting one of a first screen type, a second screen type, and a third screen type,
wherein said binary data selecting means selects binary data outputted from said first color data binarization means when the first screen type is selected by said screen type selecting means, said binary data selecting means selects binary data outputted from said second color data binarization means when the second screen type is selected by said screen type selecting means, and said binaly data selecting means selects binary data outputted from said first color binarization means with respect to color data of at least one color and binary data outputted from said second color data binarization means with respect to color data of colors other than said at least one color when the third screen type is selected by said screen type selecting means.

15. The image processing device according to claim 8, wherein said screen type selecting means is provided at an image processing terminal.

16. The image processing device according to claim 14, wherein said screen type selecting means displays a first screen type which emphasizes gradation, a second screen type which emphasizes thin lines, and a third screen type which emphasizes gradation and thin lines.

17. The image processing device according to claim 16, wherein said first color data binarization means performs binarization for gradation emphasizing screen processing upon the color data, and said second color data binarization means performs binarization for thin line emphasizing screen processing upon the color data.

18. The image processing device according to claim 17, wherein said second color data binarization means performs binarization upon said color data at a screen frequency which is higher than that of said first color data binarization means.

19. The image processing device according to claim 18, wherein, when a third screen type is selected by said screen type selecting means, said binary data selecting means selects binary data outputted from said second color data binarization means with respect to black data, and binary data outputted from said first color data binarization means with respect to color data of colors other than black.

20. The image processing device according to claim 8, wherein said binarization means performs binarization for color data such that a density of an image is represented by lines.

21. The image processing device according to claim 8, wherein said binarization means performs binarization for color data such that a density of an image is represented by dots.
